(19) United States
(12) Patent Application Publication
(10) Pub. No.: US 2017/0193178 A9
(43) Pub. Date: Jul. 6, 2017

(54) SYSTEM FOR USING MEDICATION SAMPLES TO MEASURE MEDICATION ACQUISITION AND IMPROVE PATIENT OUTCOMES

(71) Applicant: Transition Patient Services, Trevose, PA (US)

(72) Inventors: Christopher Di Lascia, Shrewsbury, NJ (US); Francis Di Lascia, Shrewsbury, NJ (US); Raman Kapur, Shrewsbury, NJ (US); Wilfred Shearer, Shrewsbury, NJ (US); Edward Sadowski, Shrewsbury, NJ (US)

(73) Assignee: Transition Patient Services, Trevose, PA (US)

(21) Appl. No.: 15/045,996

(22) Filed: Feb. 17, 2016

Related U.S. Application Data
(63) Continuation-in-part of application No. 14/827,988, filed on Aug. 17, 2015.
(60) Provisional application No. 62/037,729, filed on Aug. 15, 2014.
(60) Provisional application No. 62/206,030, filed on Aug. 17, 2015.

(51) Int. Cl. G06F 19/00; H04M 3/51; H04M 3/493

(52) U.S. Cl. CPC G06F 19/3418; H04M 3/493; H04M 3/5191

(57) ABSTRACT

Systems and methods for measuring the acquisition of a medical product by a patient are disclosed. The system may include a patient registration system, one or more patient care systems that includes at least one interactive response system. The patient registration system may capture a tracking code for the medical product the patient is taking and create an electronic patient specific data file in a database corresponding to the tracking code and the patient information. The patient care system may activate at least one system that collects patient's information, develops personalized patient monitoring parameters, receives a second set of data associated to the patient's interaction with the interactive response system, evaluate the second set of data against the personalized patient monitoring parameters, generate a feedback action plan for the user that measures patient's adherence to medical products and/or patient care systems, and triggers an intervention.

### CROSS-REFERENCE TO RELATED APPLICATION

This application is a continuation-in-part of U.S. patent application Ser. No. 14/827,988 filed Aug. 17, 2015, and also claims priority of U.S. Patent Application Ser. No. 62/206,030 filed Aug. 17, 2015, the disclosures of both applications are incorporated herein by reference in their entirety.

### BACKGROUND OF THE INVENTION

This disclosure is related to employing medication samples in monitoring and measuring acquisition pattern of medical products and further improving patient outcomes.

Healthcare providers (hospitals, health systems, accountable care organizations, physicians and medical professionals, and other healthcare providers), payers (insurers, employers and government) and manufacturers (pharmaceutical, biotech, device manufacturer) all have a vested interest in medication adherence and improved health outcomes for patients.

Medication management has been identified as a key factor in patient outcomes. This includes medication access, acquisition, and adherence. It is estimated that about 40% of patients are non-adherent to prescription medications, and up to 20% of all new prescriptions are never filled. Such poor medication management typically leads to poor patient outcomes and subsequently higher health care cost. For example up to 14% of patients with acute coronary syndromes discontinue antiplatelet medication within 30 days after the medical procedure is complete, increasing their risk of adverse events 2-fold compared with patients who filled their antiplatelet prescriptions at discharge. Similarly, up to 40% of diabetics report using less medication than prescribed because of the cost, resulting in substantially higher hemoglobin A1C levels than compliant patients. Such non-compliance leads into serious diabetic symptoms, worsening of the physical and mental functioning.

There is also no doubt that poor medication management has a negative impact on the economics of the health care with about $290 billion wasted directly from prescription abandonment. In addition, 19% of Medicare institutional discharges are followed by an adverse event within 30 days, from which two thirds are from preventable drug related events. The inability of patients to take their medication as directed is a factor in 10-25% of hospital and nursing home admissions. The Boston based Institute for Health Improvement (IHI) believes up to 46% of readmissions could be prevented if an effective pharmacotherapy can be implemented to tackle the issue of medication mismanagement.

Given the need for healthcare return on investment, as measured by the impact on patient outcomes for each dollar spent, providers are in need of tools to drive positive patient outcomes by minimizing prescription abandonment and maximizing medication adherence.

Medical Samples are medical products such as a sample or starter pack of medication or a medical device, provided to patients during the interim period prior to acquisition of the full prescription or medical device order. They are typically in a unit pack that is intended to promote the sale of the product and typically have a positive effect on patient acquisition of medication or other treatments.

Until now, a direct link between the sample and the actual acquisition of sampled medical product by patients has never been fully quantified. In the past, indirect measures, such as “sample to script ratio,” were employed to estimate the sample product conversion into actual acquisition of such product. As such, in at least the case of medications, product manufacturers have relied on the sample to script ratio measurement, calculated by the average number of prescriptions filled by a cohort of prescriber for a particular medical product, divided by the average number of samples provided to a given prescriber cohort for that product, as a way of appraising the conversion of medication sampling to the actual acquisition of the sampled medication.

While this methodology may provide a measurement of the impact of samples on the number of prescriptions filled, the method often relies on estimates of the number of prescriptions written, and does not capture the total number of prescriptions written including those that are abandoned or unfilled by the patient. Furthermore, assessing patient's therapeutic outcome while on the same therapeutic regimen, if not inaccurate, was illusive at best. Therefore, there is a need in the art to equip product manufacturers with a tool to ascertain the success of their product sampling programs, as well as empowering health care providers to accurately measure and assess the role of medical samples in patient outcomes.

### SUMMARY OF THE INVENTION

The present invention addresses the shortcomings in the prior art by describing a process and a system that establishes a direct link between provision of a medical sample product to a patient and the actual acquisition of such medical product by the patients thereby improving patient therapeutic outcome. In another aspect, the present invention provides for a process and an integrated system of technology and patient services to advance positive patient outcomes.

Embodiments concern implementing systems/apparatus and methods for tracking medical products acquisition patterns and further improving health outcomes. In at least one embodiment, the system/device may include a patient registration system that comprises a processing device configured to receive patient specific information, a code reader to scan a tracking code of a medical product, and a computer readable medium. The computer readable medium may be configured to store program instructions which, when activated and executed, cause the processor to save patient specific information and transmit the patient specific information and the tracking code to a user.

In at least one aspect of the present invention, systems for measuring the acquisition of a medical product by a patient may include one or more patient care systems, such as an interactive response system. The interactive response system may include at least a telecommunication interface configured to be in communication with one or more patient communication devices, a knowledge base and a user management system. The system may further include one or more microprocessor components programmed to: (1) receive a first set of data comprising a tracking code for the medical product and patient specific information, (2) create an electronic patient specific data file in a database corresponding to the tracking code and the patient information, (3) activate at least one or more patient care systems including at least one interactive response system, and one system collecting patient's information from a user and/or said patient, (4) develop personalized patient monitoring parameters, (5) receive a second set of data comprising information associated to the patient's interaction with one or more of said patient care systems, (6) evaluate the second set of data against the personalized patient monitoring parameters, (7) generate a feedback action plan for the user, wherein said feedback action plan measures patient's adherence to said medical product and/or said patient care systems, and (8) trigger an user authorized intervention to alert the user or patient to take one or more actions. In one embodiment, the developing of personalized patient monitoring parameters may trigger a direct patient care intervention. In one embodiment, the activation step may immediately be followed by an early intervention, such as delivery of a prescribed medical product.

In one embodiment, the interactive response system may engage patients with a series of questions and prompts patients to submit their answers via a patient communication device. In another embodiment, the system may categorize patients into different categories or calculate various assessment scores based on patients' answers, and track or monitor the acquisition of medical products by a patient. The system may further personalize a patient care plan based on the patient answers and type of medical products acquired.

In another embodiment, the medical product may be a pharmaceutical product, a prescription or a non-prescription medication, a medical device product, a dietary product, a health and fitness product or any combinations thereof. In one selective embodiment, the pharmaceutical product is a wellness kit comprising a sample medication, and a tracking code to initiate or activate the system. In one embodiment, the kit may contain a prescription order from the physician to the recipient of the kit, for the same medication sample in the kit.

Another aspect of the present invention is directed towards methods that are performed by a system for tracking sample medical products, the method may comprise (1) providing to a patient a sample medical product kit comprising a sample medical product and a corresponding tracking code, (2) receiving a first set of data comprising the tracking code of the medical product and patient specific information, (3) creating an electronic patient specific data file in a database corresponding to the tracking code and the patient information, (4) activating a series of patient care systems, wherein each one of said systems collects said patient information from a user and/or said patient, (5) developing personalized patient monitoring parameters, (6) receiving a second set of data comprising information associated to the patient's interaction with the one or more of said patient care systems, (7) evaluating the second set of data against the personalized patient monitoring parameters, and (8) generating a feedback action plan for the user, wherein said feedback action plan measures patient's adherence to said medical product. In yet another embodiment, the present invention includes triggering a user preauthorized intervention to alert the user to take one or more actions.

In yet another aspect of the invention, a computer readable medium is configured to store program instructions which, when executed, cause the processor to link a sample medical product or kit to a personalized patient care plan comprising one or more patient care system(s). Each system may correspond to a series of health related databases operable by separate instructions. As such, at least one set of instructions link patient specific information to series of monitoring parameters. In yet another embodiment, instructions are provided to compare the monitoring parameters against a second set of patient specific information that relates to patient's behavior while being managed by the sample medical product or kit. Subsequently, the instructions when executed, link the result of such comparison to triggering of one or more preauthorized intervention(s) applicable to the patient.

### BRIEF DESCRIPTION OF THE DRAWINGS

Embodiments will be described with reference to the following drawing figures, in which like numerals represent like items throughout the figures, and in which:

FIG. 1 depicts a system diagram for measuring the acquisition of a medical product by a patient according to one embodiment.

FIG. 2 depicts an example of data flow in the patient tracking system according to one embodiment.

FIG. 3 is a block diagram of an activated patient care systems showing an example of implementation of the system.

FIG. 4 depicts a hardware system for various embodiments in the disclosure.

FIG. 5 is a block diagram showing an example of the process steps of an implemented system.

### DETAILED DESCRIPTION OF THE INVENTION

Example implementations of the disclosed scenarios are described with reference to the attached figures. The figures are not drawn to scale and they are provided merely to illustrate the instant invention. Several aspects are described below with reference to example applications for illustration. It should be understood that numerous specific details, relationships, and methods are set forth to provide a full understanding of the disclosed implementations. One having ordinary skill in the relevant art, however, will readily recognize that the invention can be practiced without one or more of the specific details or with other methods. In other instances, well-known structures or operation are not shown in detail to avoid obscuring the invention. The disclosed implementations is not limited by the illustrated ordering of acts or events, as some acts may occur in different orders and/or concurrently with other acts or events. Furthermore, not all illustrated acts or events are required to implement a methodology in accordance with the disclosed scenarios.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

By the term “personalized” it is meant customization of healthcare using medical decisions, practices, and/or products being tailored to the individual patient.

By the phrase “interactive voice response” (IVR) or “interactive response system” it is meant automated phone based technology, either voice based or audio/visual based, that can be instituted for providing information, gathering survey input, and identifying data points and implementing algorithms for achieving program goals such as decreasing the readmission rate for patients by providing an interactive voice operated intervention to patients in need of such intervention.

The term “tracking code” refers to any symbol that embeds information, whether text, graphics or audio/visual information, whether human-readable or non-human-readable symbols, for identification and/or tracking of a product or a package of a product. For example, a tracking code can be a 1-D code such as UPC code, a 2-D code such as Q-R code. The tracking code can be any of the standard or proprietary codes, known or later developed.

The term “code reader” refers a device for scanning a tracking code in order to decode the embedded information in the tracking code. The “code reader” can be based on known or new arising technologies that enables reading of symbols, such as 1-D barcode reader, 2-D barcode reader, RFID reader. It can be based on infrared (IR), laser, imaging, radio frequency (RF) or other near field communication (NFC).

In a broad sense, the present invention follows such main drivers as: (a) providing a direct link between the sample medical product and an authorized user's order for such medical product, (b) providing a suite of patient services around the products through medication samples, (c) providing a mechanism for capturing medical data and linking it to patient status, (d) quantifying the value to providers and manufacturers, and (e) improving the efficacy of marketing campaigns for manufacturers.

Various scenarios described provide an integrated medical product sample system linked to patient services that measure or track acquisition of medical products and further monitor patient compliance with such medical products. The system further allows a user, such as a healthcare provider to use a sample medical product as the initiator of a patient focused process for tracking health activities such as patient's compliance, patient's behavior, and/or incentivizing compliant patient behavior. In another aspect, the present invention provides systems for quantifying the value of providing a sample product to the healthcare provider, monitoring the performance of the healthcare provider as well as assessing the manufacturer's marketing endeavors and strategies.

In one aspect of the invention, a health care provider, such as a physician, is able to assess and demonstrate improvements in the care of a patient via personalized patient metrics as of the date of enrollment of the patient in the integrated medical product sample system. This creates a value for the sample product beyond the medication itself, as the suite of services delivers improvements in adherence, monitoring, etc. thus facilitating improved patient care outcomes.

In another aspect of the invention, as a consequence to performance of the patient while on the sample medical product, the patient may receive an intervention that is designed to optimize or improve health outcome. In one embodiment, upon activation of the system, an initial early intervention may be instituted such as delivery of the prescribed medical product. In another embodiment, the system provides the user an ability to monitor, understand, or assess the overall patient behavior while on a sample medical product and/or throughout a patient specific treatment regimen.

In one aspect, the present invention may be a patient-provider driven system that employs, for example, medication samples as a bridge for assessing healthcare behavior so that all stakeholders (including patients, providers, payers, and manufacturers) benefit from creating and empowering compliant behavior.

In one aspect of the invention, a system for measuring the acquisition of a medical product by a patient is described wherein the system may comprise one or more microprocessor components programmed to: (1) receive a first set of data comprising a tracking code for the medical product and patient specific information, (2) create an electronic patient specific data file in a database corresponding to the tracking code and the patient information, (3) activate at least one patient care system from a series of patient care systems, wherein said at least one system collects said patient's information from a user and/or said patient, (4) develop personalized patient monitoring parameters, (5) receive a second set of data comprising information associated to the patient's interaction with one or more of said patient care systems, (6) evaluate the second set of data against the personalized patient monitoring parameters, (7) generate a feedback action plan for the user, wherein said feedback action plan measures patient's adherence to said medical product and/or said patient care systems, and (8) trigger an user authorized intervention to improve patient outcomes. In one embodiment, activation of the system may trigger an initial early intervention such as delivery of the product to the patient. In at least one embodiment, subsequent to developing a personalized patient monitoring parameters, the system may trigger a patient care intervention to improve patient outcomes.

One aspect of the present invention is the database for collection of the patient and product specific information. In one embodiment, the database may contain a plurality of files, each designated by a unique encrypted alphanumeric sample code corresponding to a sample medical product, such as a wellness kit. As such, each file in the database may correspond to each sample product kit used in the system, and together with the tracking code, represent the aggregate related information. The sample code may be provided by an operator, a user or be randomly generated.

The files in the database contain fields that are capable of being populated with desired information as the corresponding sample medical product, patient information, and other information provided by the user necessary to optimize treatment. In general, the fields may contain information that, for example, the manufacturing company such as a pharmaceutical company would find useful for tracking the sample per acquisition ratio. In another embodiment, the fields may be populated by information relevant to a patient's progress on the product and also physician's performance for prescribing the sample product. Examples of such fields may include for example: patient information, drug or device sample prescription quantity available at the health care provider's office, product acquisition matrix, the number of refills made or available and patient diagnosis indicators.

In at least one embodiment of this aspect, the medical product used for this system is a pharmaceutical product, a medical device product, a dietary product, a health and fitness product or any combinations thereof. In one embodiment, the medical product is a pharmaceutical product, such as a prescription or non-prescription medication. In one embodiment, the sample medical product may be a “Wellness kit” with the first component providing a direct link between the medication sample and the prescription, which is provided through the use of specific identifiers. In at least one embodiment, each sample medication can be linked to a specific patient and a specific prescriber. The identifier can be in the form of a tracking code or other like tracking mechanisms.

In yet another embodiment, the pharmaceutical product is a wellness kit that may include a sample medication, and a tracking code, optionally containing a prescription for said sampled medication. In another embodiment, the patient specific information is selected from the group consisting of patient's demographic information, patient's medical history, patient's diagnosis, patient's medication history, patient's dietary plan, patient's laboratory history, patient's insurance history and any combinations thereof. In another embodiment, the wellness kit may include a process by which the sample dispensing process initiates a prescription order at the pharmacy dispensing unit which is respectfully processed and subsequently delivered directly to the patient.

In another embodiment, the electronic patient specific data file may link the wellness kit to patient care systems. A patient care system as used herein is meant to enable the system to improve clinical outcome by any matrix suitable to assess such outcome. In one embodiment, the patient care systems are configured to perform predetermined functions associated with the first set of data. In such embodiment, the patient care systems are selected from the group that includes pharmacy system, electronic medical records system, laboratory system, insurance provider system, healthcare provider system, dietary plan system, health-fitness system, reward program system, feedback action plan system, intervention system, user intervention, patient communication systems, patient care plan compliance monitoring systems, or any combinations thereof. In one embodiment, such system may be blind to the user or the patient.

In yet another embodiment, the user of the system may be a health care provider who interacts with the patient for the purposes of performing a health care service to the patient, a health insurance administrator, a medical product manufacturer, drug manufacturer representative, personal care giver or any combinations thereof. As such, the term “user” may include “healthcare provider,” “physician,” “nurse,” “nurse practitioner” “investigator,” “drug manufacturing representative,” “physical therapist” and “health insurance representative.” The term “health care provider” further includes any one of physicians, pharmacists, nurses, nurse practitioners, physician assistants, research assistants, physician's office administrators and any combinations thereof.

In another aspect of the present invention, by the way of a user directly, or the accepted medical protocols, or patient service systems, the system may trigger authorized interventions based on user's medical order sets, standard of care guidance rules, quality measures surveillance, pharmacy operated plan of care, and any combinations thereof when certain monitoring parameters reach a predefined threshold. On the other hand, the system may pre-program such interventions after the activation of a prescribed medication.

In one embodiment, the authorized intervention can be any one of a phone call, a SMS text message, a voice message, a facsimile reminder, a computer message, an e-mail, a change in therapy, a scheduling of a home care visit, an office appointment, an offer to participate in education activities, a reward for positive healthcare behavior, a referral to admission to health care facility or any combinations thereof.

In another aspect of the present invention, the system may provide specific users, such as a manufacturer representative or a health insurance administrator, a mechanism to assess performance of another user, such as a healthcare provider. For example, the system may allow a user, such as a drug manufacturer representative or a health insurance administrator, to track conversion of a medication sample to medication acquisition. In another embodiment, the activation of system will enable a health insurance administrator to measure the performance of a health care provider by observing patient monitoring parameters.

In one embodiment, the manufacturer or seller of the medical product can access the measurements in the increased sales of the product, such as increased market share and prescription volume resulting from formulary preference, payer behaviors, and prescriber preference directly attributable to the combination of the sample product within the wellness kit. This is quantified in the incremental sales gains over baseline once the kit is put into use. Alternatively the value can further be quantified by the reduction in sampling costs as fewer samples are required to generate a prescription.

In another aspect of the present invention, methods performed by a system for tracking sample medical products may include (1) providing to a patient a sample medical product kit comprising a sample medical product and a corresponding tracking code, (2) receiving a first set of data comprising the tracking code of the medical product and patient specific information, (3) creating an electronic patient specific data file in a database corresponding to the tracking code and the patient information, (4) activating a series of patient care systems, wherein each one of said systems collects said patient information from a user and/or said patient, (5) developing personalized patient monitoring parameters, (6) receiving a second set of data comprising information associated to the patient's interaction with the one or more of said patient care systems, (7) evaluating the second set of data against the personalized patient monitoring parameters, and (8) generating a feedback action plan for the user, wherein said feedback action plan measures patient's adherence to said medical product. In at least one exemplary embodiment, the methods may further comprise triggering a user authorized intervention that, for example, is programmed into the system. In one embodiment, the method may comprise triggering a user authorized intervention for the user to take one or more actions to complete the process. In yet another embodiment, the system may prompt the need for a second user to take an action to complete the process.

In another aspect of the invention, upon the activation, the methods may further comprise generating a patient specific profile that is linked to preauthorized series of patient care systems. This facilitates adding of new content to the electronic patient specific data file by encrypting the new content into an existing string of electronic computer codes. In one exemplary embodiment, the method may comprise employing a database having a computer operated management component that assigns medical product's tracking code to an electronic patient specific data file, which corresponds to the product's tracking code.

In another embodiment, the medical product may contain a pharmaceutical product, prescription or non-prescription medication, a medical device product, a dietary product, a health and fitness product or any combinations thereof. In one exemplary embodiment, the medical product is a kit such as a wellness kit that contains a sample pharmaceutical product, a tracking code for the kit and optionally a prescription or a medical order for said sample pharmaceutical product or other patient care activity. As such, upon activating the system via the tracking code, an electronic patient specific data file, such as a prescription data file, is generated.

In one embodiment, the methods may comprise linking the patient specific prescription data file to preauthorized or pre-determined patient care systems. In one embodiment, the patient specific identification information is selected from the group that includes patient's demographic information, patient's diagnosis, patient's prescription drugs, patient's dietary plan, patient's laboratory results, patient's medical history, patient's insurance history or any combinations thereof. At the same time, the methods may comprise performing predetermined functions of each of the patient care systems associated with the patient data.

Typically, the patient care systems may include pharmacy system, electronic medical records system, laboratory system, insurance provider system, healthcare provider system, dietary plan system, health-fitness system, reward program system, feedback action plan system, intervention system, or any combinations thereof. Each system can then be accessed by the same or a different user such as a health care provider who interacts with the patient for the purposes of performing a health care service. As described above, the health care provider can be any one of a physician, a pharmacist, a nurse, a nurse practitioner, a physician assistant, a research assistant, a physician's office administrator and any combinations thereof. Such users typically dispense the actual medical sample product and activate the system. In one embodiment, the second user may be a health insurance administrator, or a product manufacturer representative.

In one embodiment, the methods may include generating authorized interventions that are designated to the patient's specific profile by any one of the mentioned users in accordance to the user's medical order sets, standard of care guidance rules, quality measures surveillance, and pharmacy operated plan of care, and any combinations thereof. The methods may further comprise executing instructions that, upon detecting that at least one patient designated monitoring parameter has reached a predetermined threshold, generate a personalized patient intervention including a phone call, a SMS text message, a voice message, a facsimile reminder, a computer message, an e-mail, a change in therapy, a scheduling of a home care visit, an office appointment, an offer to participate in education activities, a reward for positive healthcare behavior, or any combinations thereof.

In yet another embodiment, a system for tracking patient fulfillment of a personalized therapeutic regimen may include dispensing of the Wellness kit. The system may include an IVR that sends reminders to a patient that a prescription is ready for pick up or that patient is due for a new refill or that patient has not or picked up a refill within a predetermined timeframe. Upon filling of prescriptions at retail pharmacy, National Counsel for Prescription Drug Programs (NCPDP) information will be captured in real time, and the system may send a message (IVR and/or instant SMS text message) with health information and/or date for follow up visits.

For example, a patient receives medical product sample kit from a healthcare provider user, who may activate the system. Then, administrators of the site can authorize and schedule interventions for users including IVR calls, text messages, e-mails, faxes, and “live” phone calls from call center representatives. The system may schedule such interventions automatically, in any combination and frequency, individually for a distinct user or in the form of predetermined templates, based on the user data entered into the platform or imported from a database such as an electronic medical record, accepted medical practice guidelines or health insurance provider.

In one embodiment, kit activation and prescription fulfillment by a pharmacy unit is provided. In one embodiment, the kit may activate a set of patient and provider services including but not limited to product discounts, patient education, medication adherence support, reimbursement assistance, access to “live” patient support, and feedback to the physician, patient and/or caregiver.

In another embodiment, the present invention provides for data capture and linkage with precompiled medical data obtainable from other resources, such as electronic medical records, health insurance provider data bank, prior hospital admissions, medication distribution data, or the like. In another embodiment, the combined data sets will allow the creation of a link between the initial medication sample and clinical metrics indicative of changes in patient status that serve as markers for desired patient outcomes.

In at least another embodiment, the present invention provides methods and systems for monitoring patient measurements. In one embodiment, the system provides medication samples to patients to facilitate initiation of a therapy and long term success with the therapy resulting from improved knowledge of medication and disease, improved adherence, and ongoing support services. As such, in at least one embodiment, the system offers a simplified medication acquisition to address insurance coverage and reimbursement issues such as prior authorizations. In yet another embodiment, patients experience additional convenience resulting from assistance with medication access and follow up refills.

In yet another embodiment, the present invention provides patient specific systems, so that patients themselves have access to services such as a support hotline available to answer questions provides additional peace of mind or availability of discounts and co-pay assistance to reduce out-of-pocket costs.

In another embodiment, the present invention improves the healthcare quality and outcomes for patients enrolled in the program by the way of providing feedback to health care providers. In one embodiment, the feedback is used to improve the quality of drug therapy. In yet another embodiment, health care providers and health insurance payers benefit from reduced cost of care resulting from adherence to a therapeutic regimen and proper medication use.

In yet another embodiment, the healthcare provider may obtain access to additional data that is used in analyzing patient outcomes and the provider's performance.

In yet another aspect, the invention provides significant value to manufacturer by the way of directly linking the marketing activities and cost of distributing sample medical products to actual acquisition of the sampled product. For example, in one embodiment, the system facilitates a 1:1 sample to prescription ratio, which signifies the maximum return on investment for the sampling of medication. In another embodiment, the system provides the manufacturers a tool for accurate market research, particularly related to prescriber and patient activities.

In another embodiment, the instantly claimed invention provides an additional marketing tool for the manufactures to promote brand based patient loyalty through added value programs. In one embodiment, brand recognition through the methods implemented limits or dis-incentivizes the switching of a brand to generic or other competitive product through first fill from a participating pharmacy due to the value of the services directly associated with the brand product. In another embodiment, the present invention creates and incorporates a process for automated inventory control at the prescriber level by including a tracking code on each sample that is registered by the system and associated with an individual prescriber.

### Exemplary Embodiments

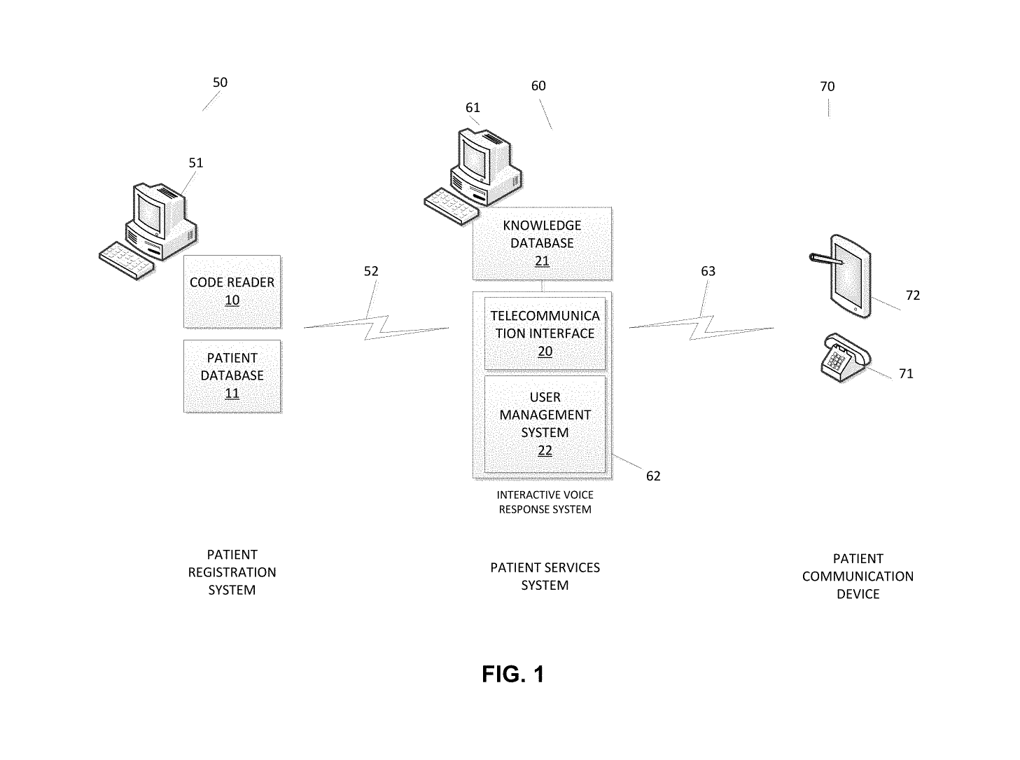

FIGS. 1-4 illustrate non-limiting embodiments of the general design of the present system. In FIG. 1, for example, a system for measuring the acquisition of a medical product by a patient may include a patient services system 60, which may include a processing device 61, and one or more patient care systems. At least one patient care system may be an interactive response system 62, which includes a telecommunication interface 20, knowledge database 21 and user management system 22. The system 60 may be in communication via a communication link 52 with a patient registration system 50 to receive information about patient and tracking code for the medical product the patient is taking. The system may be configured to create an electronic patient specific data file in a database corresponding to the track code and patient information, activate the interactive response system so that the interactive response system 62 is in communication with a patient communication device 71, 72 via a communication link 63 and may conduct a patient survey or Q&A regarding patient information, conditions and experience about the medical product. The system 62 may develop personalized patient monitoring parameters based on information in the knowledge database, receive information associated to the patient's interaction with the interactive response system and evaluate this information against the personalized patient monitoring parameters.

In one embodiment, patent registration system 50 may include a processing device, a code reader 10 that scans the tracking code for the medication product the patient is taking and a patient database 11 that stores at least patient information. In one example, the tracking code may be a symbol, a number, a code, a scanning bar, or a chip while the patient identifying information may only include a first and last name and an email address, which would typically be sufficient to individually identify a particular patient. Additional detailed information, such as that relevant to the patient's medical status, may also be included without limitation. The code reader 10 may also be any device that reads a tracking code and decodes information embedded in the code. The code reader 10 may be based on infrared (IR), imaging, radio frequency (RF) such as RFID and near field communication (NFC). The code reader may be a stationery flatbed code reading device, a hand scanner or any other type that may be suitable for scanning a barcode off a product or a package.

The interactive response system 62 communicates with a patient communication device 71, 72 via a communication link 63 coupled to a telecommunication interface 20 such as interfacing for communicating with a traditional telephone system 71, via either PSTN or VoIP based link or with a device with both audio/visual capability 72 such as a computer, a tablet or a smart phone via cellular communication network or the Internet. In one example, the interactive response system 62 first transmits survey questions stored in the knowledge database 21 for patient to respond through the patient communication device 71, 72. In one embodiment, the configuration of the interactive response system 62 can vary depending on the types of monitoring programs, types of patients or types of medical products. The configuration can be changed by the user via a user management system 22, which may be in communication with a user application via an interface in one of the protocols such as series port, USB, RJ-45, Ethernet or wireless interfaces such as Wi-Fi or Bluetooth or other near communication protocols. The user management interface may also be application programming interface (API) that allows web-based access by software applications.

In one embodiment, the system may use the knowledge database 21 to formulate survey questions to be transmitted to a patient's electronic communication device 71, 72, or predict patient's susceptibility to medical issues based on the patient's responses to the interactive response system 62. The knowledge database 21 may encompass information such as medical conditions, information about other health care providers or information about patients' present and past medical history. In one embodiment, the knowledge database 21 may be a common knowledge base. Alternatively and/or additionally, the knowledge database 21 may also contain information about patient's health conditions received by the system. In one embodiment, the knowledge database 21 may contain other underlying conditions that may be possible based on a parent condition. For example, the system may receive information that the patient is having diabetes and may retrieve medical conditions related to diabetes, such as poor circulation which may lead to foot ulcers and lower leg circulation problems or loss of toe. Based on this knowledge, the system may ask questions about the numbness of foot or lower leg when a patient is known for having diabetics.

In one embodiment, the interactive response system 62 may prompt a patient for a tracking code of the medical product and subsequently receive the tracking code from the patient communication device 71, 72 through the communication link 63. In one embodiment, the interactive response system 62 may receive a digital representation of the tracking code. The digital representation of the tracking code can be in various formats. For example, the digital representation can be a text, an image, an audio, a video or a web page containing the tracking code. The patient may enter the text code via a keypad or capture the tracking code with a code capturing device, such as a camera or microphone, and transmit the digital representation of the tracking code to the interactive response system 62 via the communication link 63.

In responding to the questions presented by the interactive response system, the patient may use the telephone keypad (physical or soft keypad on a patient communication device 71, 72) and respond to survey questions by selecting a key on the keypad. For example, the table below shows a script of the interactive response system 62 in an example vital program, which script lists a series of questions that may be transmitted to a patient communication device and the choices the patient may select on the keypad.

| Questions | Answer Keys |
|---|---|
| 1. Have you taken your vital signs today? | If yes, press 1; |
| | If no, press 2. |
| | NO = TPS alert |
| 2. Using the keypad on your phone, please | >2 lb/day = TPS alert |
| enter your weight to the nearest pound | |
| followed by the pound or number sign. | |
| 3. Have you had increased shortness of breath? | If yes, press 1; |
| | If no, press 2. |
| | YES = TPS alert-ch |
| 4. Have your ankles been more swollen than | If yes, press 1; |
| usual? | If no, press 2. |
| | YES = TPS alert-ch |
| 5. Have you experienced increased coughing | If yes, press 1; |
| or wheezing? | If no, press 2. |
| | YES = TPS alert-ch |
| 6. Have you needed to use your inhaler or | If yes, press 1; |
| nebulizer more than prescribed? | If no, press 2. |
| | YES = TPS alert |
| 7. Are you producing any sputum? | If yes, press 1; |
| | If no, press 2 |
| | If YES, then question #8. If NO, skip to |
| | question #9. |
| 8. What color is your sputum? | If clear, press 1 |
| | If yellow, press 2 = TPS alert |
| | If green, press 3 = TPS alert |
| | If brown, press 4 = TPS alert |
| 9. Again, using the keypad on your phone, | Systolic Blood Pressure <90 mmHg or >160 |
| please enter the top number only of your Blood | mm Hg with symptoms (alarmed on questions |
| Pressure reading followed by the pound or | 2-8): = TPS alert |
| number sign. | Systolic Blood Pressure <80 mmHg or >170 |
| | mmHg without symptoms (did not alarm on |
| | questions 2-8): = TPS alert |
| 10. Once more, using the keypad on your | Heart Rate <50 or >100 with Symptoms |
| phone, please enter your Heart Rate followed | (alarmed on questions 2-8): = TPS alert |
| by the pound or number sign. | Heart Rate <40 or >110 without symptoms (did |
| | not alarm on questions 2-8): = TPS alert |
| 11. Are you taking your medications as | If yes, press 1; |
| prescribed? | If no, press 2. |
| | NO = TPS alert |
| 12. Are you following your recommended | If yes, press 1; |
| diet? | If no, press 2. |
| | NO = TPS alert |
| 13. Please describe how you feel today. | If you feel well, press 1 |
| | If you feel just ok, press 2 = TPS alert (unless |
| | no other symptoms) |
| | If you are not feeling well, press 3 = TPS alert |
| | If you feel your condition is worsening, please |
| | seek medical attention. |

Based on the results of the survey, the system may determine whether there is a “Red Flag” so as to classify and triage incoming patients, which allows the system to quickly and accurately assign highly targeted health education or reporting programs specific to the needs of that type of patient. The system may further follow up with more survey sessions for patients who have exhibited “Red Flag” as the result of the previous survey.

In another embodiment, the interactive response system 62 can be employed to interact with patients with a medical condition such as COPD (chronic obstructive pulmonary disease). The table below lists, for example, a list of questions asked by the interactive response system.

| | |
|---|---|
| Questions | Scoring |

METRICS ABOUT PATIENT

| | |
|---|---|
| Height? | The resulting score of the test will give |
| Weight? | us the patient's level of disease acuity |
| Heart Rate? | e.g. Score of 25 or higher is high |
| Blood Pressure? | disease acuity. |
| Creatinine Clearance? | |
| Liver Enzymes ALT/AST | |
| Hematocrit | |
| White Blood Cell Count? | |
| Current Medications with doses? (number of meds | |
| and doses compared to median dictates score) | |
| Oxygen? | |
| History of smoking? (date of last cigarette, pack per | |
| day dictates score) | |
| Comorbidities? (e.g. diabetes, CHF, Asthma etc., | |
| Number and type dictates score) | |

MEDICATION ADHERENCE QUESTIONS

| | |
|---|---|
| Do you sometimes forget to take your pills? | The resulting score of the test will give |
| Are you careless at times about taking your | us the risk of medication non- |
| medicine? | adherence |
| People sometimes miss taking their medications for | e.g. Score of 25 or higher is high risk |
| reasons other than forgetting. Thinking over the | for medication non-adherence |
| past two weeks, were there any days when you did | |
| not take your medicine? | |
| Sometimes if you feel worse when you take the | |
| medicine, do you stop taking it? | |
| Have you ever cut back or stopped taking your | |
| medicine without telling your doctor because you | |
| felt worse when you took it? | |
| When you travel or leave home, do you sometimes | |
| forget to bring along your medicine? | |
| Did you take all your medicine yesterday? | |
| When you feel better do you sometimes stop taking | |
| your medicine? | |
| When you feel like your symptoms are under | |
| control, do you sometimes stop taking your | |
| medicine? | |
| Taking medicine every day is a real inconvenience | |
| for some people. Do you ever feel hassled about | |
| sticking to your treatment plan? | |
| How often do you have difficulty remembering to | |
| take all your medicine? (A. Never/rarely; B. Once | |
| in a while; C. Sometimes; D. Usually E. All the | |
| time) | |

In one embodiment, the metrics about patients may further be retrieved by the system from an electronic health record database or patient database 11. In one embodiment, the interactive response system may further ask patients additional questions specific to each disease state that they are qualified with. For example, the following table lists questions that ask for answers of scale of 1 to 5 as to how true the following statements are. The system may compute a resulting score based on the answers from the patient. Various algorithms can be used to calculate the resulting score depending on the types of disease to which the questions are pertaining. In one embodiment, the system may convert patient's answers to a numerical scale, e.g. 1 to 5, and assign weights to each question. The system may then multiply the weight to each question by the numerical scale of each corresponding answer, and sum the total to derive a resulting score. The resulting score of the test may indicate the severity level e.g. score of 25 or higher is level 4 COPD.

In one example, the system may use a machine learning network to learn the weights and other parameters necessary to determine the severity level of the disease. For example, in using the machine learning framework, the system may collect a sample set that contains a group of questions and a patient's answers to each of the questions, and the resulting health condition (e.g. level 4 COPD). The system may use these known data to learn the weights and one or more parameters of a model. Then the system may ask the patient a series of questions and use the learned model to derive medical conditions of the patient based on the patient's answers to the given questions. Other algorithms, known or later developed, such as fuzzy logic or another machine learning networks, may also be used.

| LOW = 1 | HIGH = 5 |
|---|---|
| I never cough | I cough all the time |
| I have no phlegm (mucus) in my | My chest is full of phlegm |
| chest at all | (mucus) |
| My chest does not feel tight at all | My chest feels very tight |
| When I walk up a hill or one flight | When I walk up a hill or one flight |
| of stairs I am not breathless | of stairs I am very breathless |
| I am not limited doing any activities | I am very limited doing activities |
| at home | at home |
| I am confident leaving my home | I am not at all confident leaving my |
| despite my lung condition | home because of my lung condition |
| I sleep soundly | I don't sleep soundly because of my |
| | lung condition |
| I have lots of ENERGY | I have no energy at all |

In one embodiment, depending on the scores from these exemplary questions and the patient condition at the level specified, the interactive response system may automatically enroll the patient in a customized program or subscribe the patient to continual educational content that is specific to their condition and severity level. In one embodiment, the system may employ a feedback loop and monitoring, in which each of the disease state IVR questions has alerts for specific answers to routine questions. The patient's condition level is constantly modified based upon their ongoing answers to the routine questions.

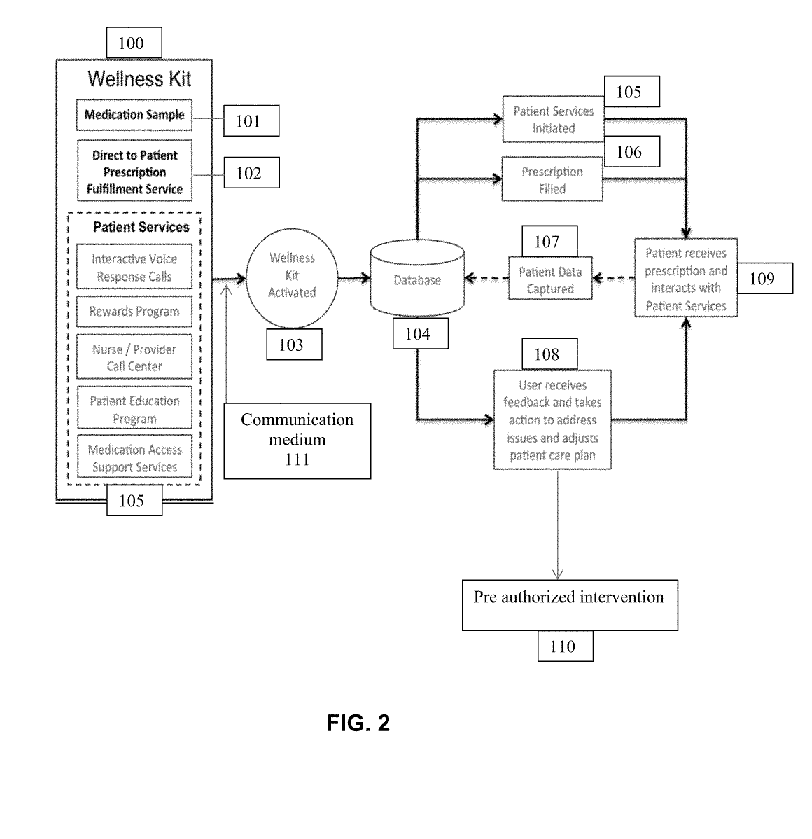

In one embodiment, with reference to FIG. 2, for example, a wellness kit 100 containing a tracking component, such as a tracking code and a sample prescription medication 101 is provided. The tracking code allows for directly linking the kit containing a medication sample to a prescription and a patient. The wellness kit also provides the option of linking said kit to a suite of patient services systems 102. Once activated 103, the system registers said kit and patient specific information in a database operated by a computerized management system and triggers the pharmacy system to fill 106 and dispense the prescribed medication by directly interacting with the patient 109. The database management as instructed then captures relevant data concerning the dispensing to and interacting with the patient, thereby providing feedback to a user for taking necessary steps to optimize the patient care plan 108. Such steps can be predetermined, preauthorized or preprogramed into the management data system, thereby triggering an authorized patient intervention 110.

In one aspect of the present invention, the presented system provides for a user system, which enables a user such as a healthcare provider, i.e. a physician. Such user system enables the healthcare provider to dispense a medical product sample kit and activate the system through communication mediums 111 via a computing apparatus/device for operating for example a web browser. The activation step can be performed by the way of a prescription being submitted through an electronic prescribing software platform, a facsimile, a phone call from the prescriber, or alike to activate pharmacy system. The computing apparatus/device is such that it enables the user to remotely access the system, for example the web site, through the communication medium such as the web, telephone line, wireless communications or the like to further monitor patient's progress on the prescribed therapeutic regime. Examples of the computing apparatus/device include a desktop computer, a lap top computer, a personal digital assistant, a computing tablet, an interactive wireless communications device, a handheld computer, a computer server, or the like, which connects with the communication medium. Additionally, the computing apparatus/device may include any one of peripheral devices that is linked or cooperates with the computing apparatus/device, such as a printer, a scanner, a bar code scanner, facsimile machine and the like.

In another aspect of the invention, a pharmacy system is employed to receive actual prescription orders from a computer management system and then routes them to the appropriate processor for proper function. Once activated by a health care provider the system may prompt through the pharmacy system a series of instructions requiring input from a pharmacy unit. Once appropriate instructions are executed a personalized patient profile is generated that is able to be linked to other patient care service/systems. The system also provides for the user an access to update patient care plan further allowing health outcome measurements. In one embodiment, a single user such as a health care administrator from physician's office, hospital, a pharmacy can activate the system to execute all process steps in an automated process. According to this embodiment, other users may be prompted remotely to take necessary actions to activate a given service system.

In one embodiment, the user is a pharmacist, pharmacy technician or ancillary health care professional who activates the system upon receiving a tracking code for the sample medicinal product or a wellness kit. As such, the user identifies patient specific information for the purpose of interacting with the system by the way of a tracking code or device that is preassigned to the sample medication product or kit. Once activated 103, the system captures the user and the patient's data into a database 104 which can be used for activation of various patient systems 105, each of which may trigger a separate series of instructions specific to said system. This information may be stored in a database 104.

In at least one embodiment the patient has the ability to interact with the system directly to provide specific pre-assigned monitoring parameter at a pharmacy, such as filling a prescription 106, in conjunction with optionally activating other health care systems. Patient compliance is then assessed based on series of patient data capture 107 and run against series of predetermined monitoring parameters. Upon comparison of the monitoring parameters and patient specific data captured, the system triggers an intervention in any form found appropriate 110.

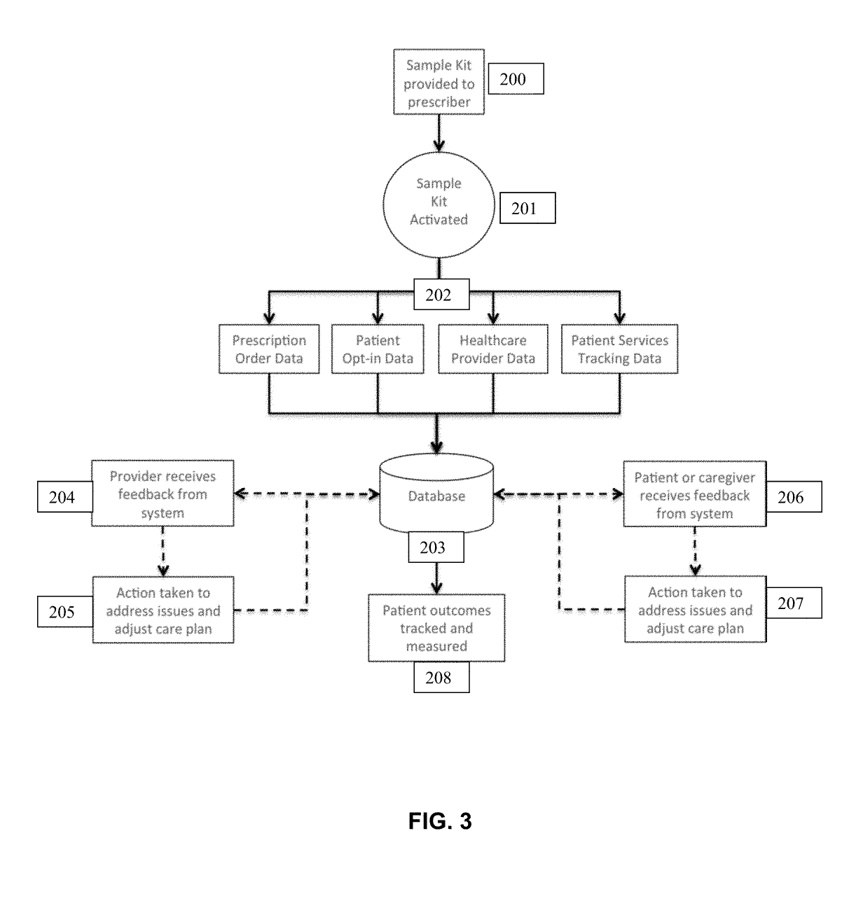

Referring now to FIG. 3, in one embodiment, a user such as a physician or a physician's office staff, initiates the system by providing a sample medication to a patient 200 and activating the system 201. The actual activation step is through transmission of a collective set of data combined or paired together, which may then be split into different transmissions at the computer management system level 202, with the prescription order data, patient opt-in data, healthcare provider data and patient services tracking data, being submitted for delivery to the chosen pharmacy services. Data respectively stored in designated pharmacy services 203 enabling feedback loops to the users and patients.

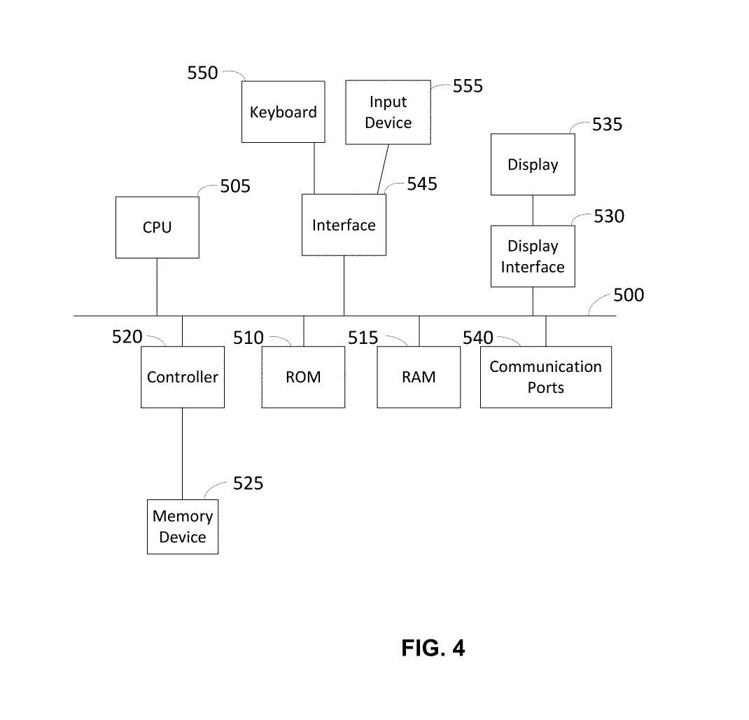

FIG. 4 is a block diagram showing various hardware components that may be part of a system for tracking and measuring acquisition of medical products by a patient. For example, any of the systems/devices or processing devices shown in FIG. 1 may include similar internal hardware architecture such as that illustrated in FIG. 4. An electrical bus 500 serves as an information highway or communication link interconnecting the other illustrated components of the hardware. CPU 505 is a central processing unit of the system, performing calculations and logic operations required to execute a program. CPU 505, alone or in conjunction with one or more of the other elements disclosed in FIG. 4, is a processing device, computing device or processor as such terms are used within this disclosure. Read only memory (ROM) 510 and random access memory (RAM) 515 constitute examples of memory devices.

A controller 520 interfaces with one or more optional memory devices 525 that service as data storage facilities to the system bus 500. These memory devices 525 may include, for example, an external DVD drive or CD ROM drive, a hard drive, flash memory, a USB drive or another type of device that serves as a data storage facility. As indicated previously, these various drives and controllers are optional devices. Additionally, the memory devices 525 may be configured to include individual files for storing any software systems or instructions, auxiliary data, incident data, common files for storing groups of contingency tables and/or regression models, or one or more databases for storing the information as discussed above.

Program instructions, software or interactive systems for performing any of the functional steps associated with the processes as described above may be stored in the ROM 510 and/or the RAM 515. Optionally, the program instructions may be stored on a non-transitory computer readable medium such as a compact disk, a digital disk, flash memory, a memory card, a USB drive, an optical disc storage medium, a distributed computer storage platform such as a cloud-based architecture, and/or other recording medium.

A display interface 530 may permit information from the bus 500 to be displayed on the display 535 in audio, visual, graphic or alphanumeric format. Communication with external devices may occur using various communication ports 540. A communication port 540 may be attached to a communications network, such as the Internet, a local area network or a cellular telephone data network. In this regard, it should be understood that the microprocessor can access and run various software applications stored on the non-transitory storage medium e.g. 510, 525. Such applications can facilitate different health service or patient care systems, health insurance data and electronic patient history.

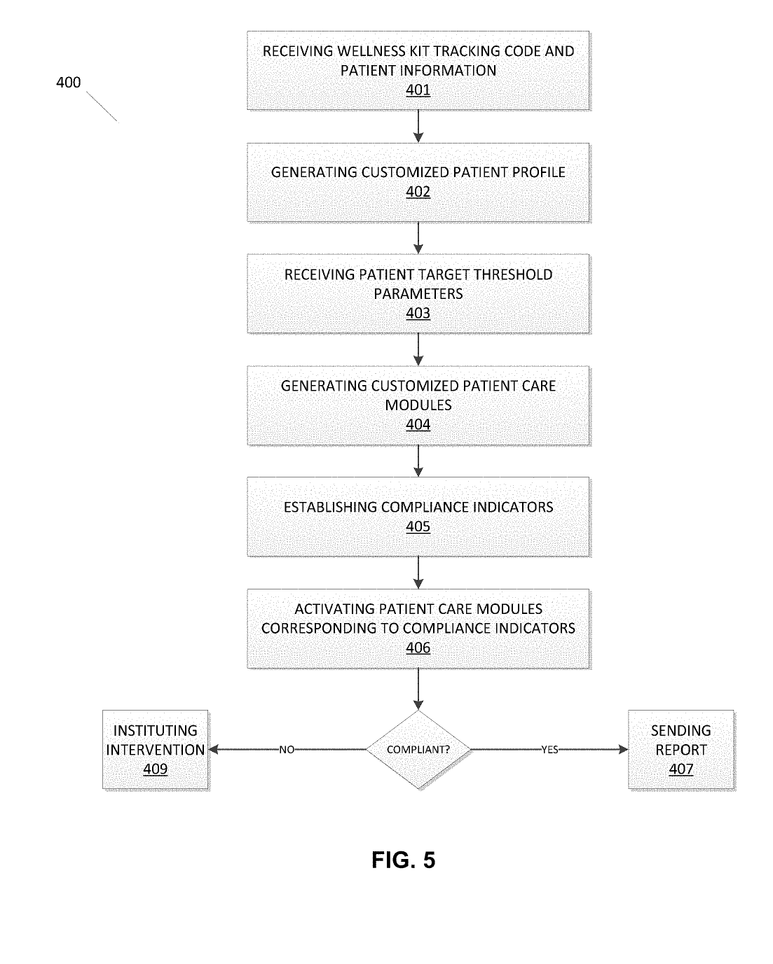

Referring now to FIG. 5, in an example system 400 for measuring the acquisition of medical products and triggering interventions, the system may receive sample medical product kit tracking information and patient identifying information 401. Based on the patient identifying information, the system may generate a personalized patient profile 402. The patient profile may include both public and non-public (i.e. private) components. The public patient profile includes profile information which is visible to healthcare providers or health insurance users registered on the platform or any user accessing the website. The site owner or any given user may decide to restrict access to profile information to only registered users or may allow public information to be freely accessible without registration. The private profile may include more sensitive information including the patient's medical history and the like. The private profile may only be accessible by the patient and other privileged users which obtain the patients permission in exchange for access to the private profile data. For example, a patient may wish to allow his/her primary care physician to have access to the private profile data.

The system may also receive patient care target thresholds 403. Patient care target thresholds identify particular conditions, clinical outcomes, proposed diet regimen, and/or medications compliance associated with the patient. For example, the patient may have type I diabetes and have a prescription for insulin. Both “type I diabetes” and “insulin” are each patient care target thresholds. Each may be represented by a code or other indicator which the system can use to identify compliance or non-compliance.

In one embodiment, using the profile data and patient care target thresholds, the system may generate a personalized patient care plan that includes one or more patient care systems 404. Various combinations of patient profile data and patient care target thresholds may suggest particular patient care systems to be included in the patient care plan. For example, if a patient leaves a physician's office with a blood pressure medicine wellness kit, either the physician's administrator or a participating pharmacy can activate the system. In the scenario that a pharmacist at a participating pharmacy activates the system, the sample medication to acquisition of the product is indeed one to one. As such, when the prescribed medication is registered within the patient's profile, the platform may generate a patient care plan with a preauthorized intervention through, the physician's office itself, or through an accepted medical care plan or a health care provider's approved standard of care protocol.

In one embodiment, a patient care plan may include a follow up office visit within a set amount of time. The office visits schedule may represent another patient care system for the patient to comply with. Alternatively and/or additionally, the system may include educational systems designed to inform the patient on the importance of taking the prescribed medication. For example, patient care systems may include a suggested dietary regimen, a suggested fitness regimen, and/or any other activity or course of action which is recommended and/or assigned to the patient by a user.

The system may also establish one or more compliance indicators 405. A compliance indicator is data that indicates whether the patient has complied with a particular patient care system upon activation of the wellness kit. For example, if the patient is supposed to visit his or her physician within two weeks of activation of the wellness kit, data may be received with indications whether the patient has or has not complied with such visit. The indicator may also be an absence of data, e.g. that no data has been received indicating the prescription has been filled or refilled. In either case, the platform receives an indication that at least some portion of the system has not been complied with.

With further reference to FIG. 5, the system may activate one or more patient care systems based on the compliance indicators 406. As used in this document, compliance means that the patient has engaged in an optimal activity. For example, if the patient is supposed to fill a prescription within a set amount of time, the patient is compliant if the prescription is filled within the amount of time given. The patient is not compliant (i.e., non-compliant) if the prescription has not been filled within the amount of time given. If the patient is compliant, the system may send a report 407 to the secondary user such as a health insurance administrator or a product manufacturing representative as to the effectiveness of the regimen for such patient. If, however, the patient is not compliant, the system may institute an appropriate authorized intervention 408 by placing notifications on the system website, sending an SMS message, sending an email, placing an IVR phone call, sending a fax, contacting health care provider and the like. If the non-compliance is determined to be critical, the system performs a provider defined intervention for critical activities.

While the present invention has been described with reference to certain embodiments, it will be understood by those skilled in the art that various changes may be made and equivalents may be substituted without departing from the scope of the present invention. In addition, many modifications may be made to adapt a particular situation or material to the ‘teachings of the present invention without departing from its scope. Therefore, it is intended that the present invention not be limited to the particular embodiment disclosed, but that the present invention will include all embodiments falling within the scope of the appended claims.

1. A system for measuring the acquisition of a medical product by a patient, comprising:
a processing device;
a knowledge database for storing information related to a medical product;
a patient care system comprising at least an interactive response system, the interactive response system comprising:
a telecommunication interface,
a user management system; and
a hardware-based non-transitory storage medium operably connected to the processing device and configured to store a patient database and a set of instructions that, when executed, cause the processing device to:
receive a first set of data comprising a tracking code for the medical product and patient specific information of a patient receiving the medical product,
create an electronic patient specific data file in a database corresponding to the first set of data,
activate the interactive response system so that the interactive voice response system is in communication with a patient communication device via a telecommunication link,
develop personalized patient monitoring parameters,
receive a second set of data comprising information associated to the patient's interaction with the interactive response system,
evaluate the second set of data against the personalized patient monitoring parameters,
generate a feedback action plan, wherein the feedback action plan measures patient's adherence to the medical product, and
trigger an user authorized intervention, wherein the user authorized intervention alerts a user or the patient to take one or more actions.

2. The system of claim 1, further comprising a patient registration system, the patient registration system comprising:
a code reader configured to scan the tracking code for the medical product;
a second processing device; and
a hardware-based non-transitory storage medium operably connected to the second processing device and configured to store a patient database and a set of instructions that, when executed, cause the processing device to:
save the patent specific information in the patient database, and
transmit the scanned tracking code for the medical product and the patient specific information to the processing device.

3. The system of claim 1, further comprising one or more additional patient care systems, wherein the set of instructions comprise further instructions for causing the processing device to activate the one or more additional patient care systems so that the one or more additional patient care systems are in communication with the patient, wherein the second set of data further comprises information associated to the patient's interaction with the one or more additional patient care systems.

4. The system of claim 1, wherein instructions for developing personalized patient monitoring parameters comprise further instructions for causing the processing device to trigger a patient care intervention.

5. The system of claim 1, wherein the medical product is a wellness kit comprising a sample medication, and a tracking code.

6. The system of claim 5, wherein the wellness kit further comprises a prescription for the sample medication.

7. The system of claim 5, wherein the electronic patient specific data file links the wellness kit to the patient care system.

8. The system of claim 1, wherein the patient specific information is selected from the group consisting of patient's demographic information, patient's medical history, patient's diagnosis, patient's medication history, patient's dietary plan, patient's laboratory history, patient's insurance history and any combinations thereof.

9. The system of claim 3, wherein each of the patient care systems is configured to perform predetermined functions associated with the first set of data.

10. The system of claim 9, wherein the patient care systems are selected from the group consisting of pharmacy system, electronic medical records system, laboratory system, insurance provider system, healthcare provider system, dietary plan system, health-fitness system, reward program system, feedback action plan system, intervention system, user intervention, patient communication systems, patient care plan compliance monitoring systems, and any combinations thereof.

11. The system of claim 1, wherein the authorized intervention comprises user's medical order sets, standard of care guidance rules, quality measures surveillance, pharmacy operated plan of care or any combinations thereof.

12. The system of claim 1, wherein the user authorized intervention comprises a phone call, a SMS text message, a voice message, a facsimile reminder, a computer message, an e-mail, a change in therapy, a scheduling of a home care visit, an office appointment, an offer to participate in education activities, a reward for positive healthcare behavior, a referral to admission to health care facility or any combinations thereof.

13. The system of claim 1, wherein the feedback action plan further measures medication sample to prescription ratio.

14. The system of claim 1, wherein the feedback action plan further measures efficacy of the medication sample and/or patient's compliance with said medication.

15. The system of claim 2, wherein the code reader is selected from a group consisting of 1-D barcode reader, 2-D barcode reader, RFID reader and a symbol reader.

16. The system of claim 2, wherein the code reader is a selected from a group consisting of laser reader, imaging reader, RF reader, infrared reader and near-field communication reader.

17. The system of claim 1, wherein the telecommunication interface is based on PSTN, VoIP, or cellular based telecommunication protocol.

18. The system of claim 1, wherein the user management application program comprises an application program interface (API) and is configurable via a web browser.

19. The system of claim 1, wherein the instructions for receiving the tracking code further comprises additional instructions that, when executed, cause the interactive response system to receive a digital representation of the tracking code from the patient communication device via a telecommunication link.

20. The system of claim 19, wherein the digital representation of the tracking code is a text, an audio, a video, an image or a web page.

21. The system of claim 1, wherein the patient communication device is a telephone, an audio device or a computing device.

22. A method for tracking sample medical products, the method comprising:
receiving, by a processing device, a tracking code for a medical product;
receiving, by the processing device, a first set of data comprising the tracking code of the medical product and patient specific information for a patient;
creating, by the processing device, an electronic patient specific data file in a database corresponding to the first set of data;
activating, by the processing device, one or more patient care systems, wherein each one of said systems collects the patient information, and wherein the one or more patient care systems comprises at least one interactive response system in communication with a patient communication device via a communication network;
developing, by the processing device, personalized patient monitoring parameters;
receiving, by the interactive response system, a second set of data comprising information associated to the patient's interaction with the interactive response system;
evaluating, by the processing device, the second set of data against the personalized patient monitoring parameters; and
generating a feedback action plan, wherein said feedback action plan measures patient's adherence to said medical product.

23. The method of claim 22, wherein receiving the tracking code comprising receiving, by the interactive response system, a digital representation of the tracking code from the patient communication device via the communication network.

24. The method of claim 23, wherein the digital representation of the tracking code is a text, an audio, a video, an image or a web page.

25. The system of claim 22, wherein the patient communication device is a telephone, an audio device or a computing device.
